(19) United States
(12) Patent Application Publication
(10) Pub. No.: US 2006/0204692 A1
(43) Pub. Date: Sep. 14, 2006

(54) Cathode ray tube-use glass panel and inspection method therefore and inspection device therefor

(76) Inventors: Shigehiko Akiyama, Shiga (JP); Yoshio Kirihata, Shiga (JP); Takashi Mikuni, Shiga (JP); Mamoru Kubosaka, Shiga (JP)

Correspondence Address: J.C. Patents, 4 Venture, Suite 250, Irvine, CA, 92618, US

(21) Appl. No.: 10/511,791

(22) PCT Filed: Apr. 14, 2003
(86) PCT No.: PCT/JP03/04752

§ 371 Date: Oct. 14, 2004

(30) Foreign Application Priority Data
Apr. 17, 2002 (JP) 2002-115535
Apr. 8, 2003 (JP) 2003-104392

(51) Int. Cl. B28B 11/00

(52) U.S. Cl. 428/34.4

(57) ABSTRACT

Ultrasonic waves are used to detect the size and the depth of an internal defect S in the face portion 2 of a panel 1. Preferably, the ultrasonic wave is transmitted from the outer surface 2a side of the face portion 2 toward the inner surface 2b to receive a reflected wave reflected on the inner surface 2b side, thereby detecting the size of the internal defect S and the distance of the internal defect S from the inner surface 2a. Upon transmission and reception of the ultrasonic wave, the ultrasonic wave is allowed to propagate through a non-compressive fluid as a medium outside the face portion 2.

### BACKGROUND OF THE INVENTION

The present invention relates to glass panels for a cathode-ray tube, and a method and an apparatus for inspecting the glass panel, and more particularly, to a technique for detecting an internal defect present in the face portion of the cathode-ray tube glass panel.

In general, the so-called direct-view cathode-ray tube and projection cathode-ray tube are well known as a cathode-ray tube which is a component of television receivers or the like. These cathode-ray tubes are constructed to include a panel having a substantially rectangular face portion on which an image is displayed, and a funnel having a substantially tapered side-wall portion which extends from a substantially rectangular increased-diameter opening portion to a substantially circular reduced-diameter opening portion, in which a neck portion into which an electron gun is inserted is provided consecutively at the reduced-diameter opening portion of the funnel. A mold made up of male and female molds is used for pressing molten glass to thereby produce the panel and the funnel.

The direct-view cathode-ray tube is configured to display an image by arranging, e.g., light beams of each color on a fluorescent film formed on the inner surface of the panel. In contrast to this, the projection cathode-ray tube is configured to illuminate a fluorescent film with an electron beam, the film being formed on the inner surface of the panel and allowed to emit a predetermined light beam, to project an enlarged image onto a screen via a projection lens system having the focal point on the fluorescent film, thereby displaying the image.

The panel constituting these cathode-ray tubes is checked singly or in combination with the funnel sealingly integrated with the panel into a glass bulb, for an internal defect in the face portion caused by inclusion of air bubbles, foreign matters (solid), or the like. These internal defects are mainly caused in the step of melting raw glass materials through the aforementioned pressing step. Thus, the inspection of a panel is usually performed after each processing related to the fabrication of the panel has been completed, whereas the inspection of a glass bulb is performed, for example, after the panel and the funnel are sealingly integrated and each of other components are attached thereto.

Conventionally, an inspection of panels of this type has been conducted visually by an operator or using an optical camera such CCD cameras. In this inspection, since an extremely large defect or an extremely large number of defects detected on a panel or glass bulb would have a seriously adverse effect on an image to be displayed, the panel or glass bulb is discarded in practice.

Recently, as disclosed in Japanese Patent Publications No. Hei 06-018486 and No. Hei 05-273180, ultrasonic waves have also been used to check for a defect in an object to be inspected (e.g., a panel).

The conventional technique of inspecting for an internal defect in a panel visually or using an optical camera will provide only two-dimensional knowledge on the presence of an internal defect in planes parallel to the inner and outer surfaces of the face portion, thus raising the problems discussed below.

That is, such an inspection technique cannot provide knowledge on the presence of internal defects in the direction of thickness of the face portion (in the direction parallel to the tube axis). For example, it is thus impossible to clearly grasp the difference between internal defects concentrated on the outer surface side of the face portion and/or those concentrated on the inner surface side contrary thereto.

More specifically, it is impossible to clearly distinguish between internal defects S′ present across the entire area in the direction of thickness of a face portion 2′ of a panel 1′ as shown in FIG. 7(a), internal defects S′ present only in the vicinity of an outer surface 2a′ of the face portion 2′ as shown in FIG. 7(b), and internal defects S′ present only in the vicinity of an inner surface 2b′ of the face portion 2′ as shown in FIG. 7(c).

Suppose that it is found where internal defects are concentrated in the direction of thickness of the face portion. In this case, it would be possible to easily know the cause of such defects, e.g., an error in the glass melting conditions, a defect in the glass melting furnace, or a mistake of recognizing the glass components. Nevertheless, this possibility is ruined for the reason mentioned above.

Accordingly, it has to be attempted to prevent the occurrence of the internal defects by trial and error or the like with no action being taken against the error in the glass melting conditions, the defect in the glass melting furnace, or the glass components and these causes remaining as they are. This may cause not only a time-consuming and complicated action against the defects but also a delay in solving the problems.

In particular, since the panel used for the projection cathode-ray tube has the focal point of the projection lens system on the inner surface (fluorescent film) of the face portion, any internal defect present in the vicinity of the inner surface would be magnified and displayed in an image, e.g., as a black object. In contrast to this, suppose that an internal defect is present in the vicinity of the middle of the face portion in the direction of its thickness or in the vicinity of the outer surface. In this case, the internal defect tends to be blurred in a wider area beyond recognition due to the lens effect of the internal defect being spaced apart from the focal point of the lens system.

Accordingly, when a defect is present in the vicinity of the middle of the face portion in the direction of its thickness or the outer surface, i.e., except in the vicinity of the inner surface, the panel could be employed for use. However, the aforementioned technique of checking for a defect in a plane would determine the panel to be defective, leading to a mislead action of discarding the panel or the glass bulb.

Such a mislead determination or mislead action would cause a wasteful step in fabricating the panel or the glass bulb as well as an unnecessary increase in manufacturing costs, seriously impeding the smoothness of the manufacturing steps and the shortening of a manufacturing period.

On the other hand, a recent doubling or higher density of scan lines has caused an internal defect present in the vicinity of the inner surface of the panel face portion to have a profoundly adverse effect on an image. It has thus become critical how to properly detect the internal defect.

Even the apparatus disclosed in Japanese Patent Publications No. Hei 06-018486 and No. Hei 05-273180 would only make it possible to check for the presence of a defect using ultrasonic waves. Thus, as in the case described above, the presence of a defect can be grasped only two-dimensionally in practice, still leaving the aforementioned problems unsolved which are caused by the mislead determination or the mislead action.

### SUMMARY OF THE INVENTION

It is an object of the present invention to readily and accurately detect not only the presence of a defect on a plane parallel to the inner and outer surfaces of the face portion of a panel but also the presence of an internal defect in the face portion in the direction of its thickness in order to avoid complicating of the countermeasure action against defects or unreasonable discarding of panels or bulbs, caused by the presence of internal defects incapable of being known three-dimensionally.

To achieve the aforementioned object, a method according to the present invention is one for inspecting a glass panel for a cathode-ray tube, which includes a substantially rectangular face portion and a skirt portion attached consecutively in a substantially perpendicular manner to a peripheral edge of the face portion. The method is characterized by detecting the size and the depth of an internal defect in the face portion using ultrasonic waves.

As used herein, “the depth of an internal defect” means the depth from the inner surface or the outer surface of the face portion in the direction of its thickness toward the inside thereof. An inspection of a glass panel may be performed on the glass panel or on a glass bulb into which the glass panel and a glass funnel are sealingly integrated.

Based on the characteristics of a reflected wave of the ultrasonic waves or the intensity characteristics of the reflected wave, such an arrangement makes it possible to know not only the presence and the size of an internal defect in a plane substantially parallel to the inner and outer surfaces of the face portion but also the position of presence of the internal defect in the direction of thickness of the face portion, i.e., the depth. This makes it possible to correctly grasp the presence of an internal defect three-dimensionally, allowing for avoiding complication of the countermeasure action against defects or elongation of the action duration as well as avoiding effectively a mislead determination on the position of the internal defect or a mislead action for disposal, which would be otherwise experienced as in the conventional case where the presence of an internal defect was grasped only two-dimensionally.

In this case, it is preferable to emit ultrasonic waves from any one of the inner and outer surfaces of the face portion toward the other surface and receive a reflected wave reflected on the other surface and an internal defect, thereby detecting the size of the internal defect and the distance of the internal defect from the other surface.

With this arrangement, an ultrasonic wave from the one surface side which is reflected on the entry to the face portion includes a large amount of noise, thereby making it impossible to accurately detect an internal defect in the vicinity of the one surface. On the other hand, an ultrasonic wave reflected on the other surface side has a sharp waveform with less noise, thus making it possible to accurately detect an internal defect in the vicinity of the other surface. Accordingly, this reflected wave could be used effectively to accurately detect the size of an internal defect in the vicinity of the other surface and the distance of the internal defect from the other surface. More specifically, an ultrasonic-wave transmitter (which also includes a receiver, hereinafter having the same configuration) being spaced apart from one surface of the face portion would cause the ultrasonic wave to be attenuated so as not to properly detect an internal defect. Thus, this requires the placement of the ultrasonic-wave transmitter in close proximity to the one surface. However, this proximate placement would allow ultrasonic waves to propagate back and forth between the one surface and the transmitter, thereby causing noise to grow and accordingly enlarging an area in which an internal defect cannot be detected. In this context, to provide a larger area in which an internal defect can be detected on the side where the reflected wave with less noise is generated, it is essential to allow ultrasonic waves to enter through a surface opposite to the surface side where the reflected wave is generated.

Preferably, in some cases, ultrasonic waves are emitted from the outer surface side of the face portion toward the inner surface side to receive a reflected wave reflected on the inner surface and an internal defect, thereby detecting the size of the internal defect and the distance of the internal defect from the inner surface.

With this arrangement, as can be seen from the characteristics of the aforementioned reflected ultrasonic wave, an internal defect present in the vicinity of the inner surface of the face portion is accurately detected by means of a sharp reflected wave. This allows for conveniently inspecting an internal defect especially in a projection cathode-ray tube panel for which an internal defect in the vicinity of the inner surface of the face portion is considered to be critical. In this case, a panel having an internal defect found to be 0.15 mm or more in diameter or maximum length within an area of 5 mm from the inner surface of the face portion would be determined to be defective and thus to be discarded. On the other hand, by way of example, a panel having an internal defect found in the other area to be about 0.5 mm or less in diameter or maximum length would be determined to be acceptable.

To ascertain the inspection method arranged as described above, it is preferable to allow ultrasonic waves to propagate through a non-compressive fluid as a medium outside the face portion upon transmission and reception of the ultrasonic waves.

That is, suppose that ultrasonic waves propagate through a non-compressive fluid as a medium until the ultrasonic waves enter into the face portion from the transmitter. In this case, the oscillatory energy of the ultrasonic waves is used for deformation of the non-compressive fluid and thereby attenuated. However, the present invention allows the ultrasonic waves to propagate through a non-compressive fluid outside the face portion, thereby hardly causing the oscillatory energy to significantly decrease or the ultrasonic waves to attenuate accordingly.

In this case, the non-compressive fluid can be a cylindrical flowing fluid that covers a path for transmission and reception of the ultrasonic waves and has a fluid channel area smaller than the inner and outer surfaces of the face portion.

With this arrangement, in connection with the path for transmission and reception of the ultrasonic waves, the fluid channel area of the cylindrical flowing fluid is not unnecessarily increased, thus allowing the ultrasonic waves to propagate through the non-compressive fluid without requiring an unnecessary amount of flowing fluid. In this case, it is necessary to provide the path for transmission and reception of the ultrasonic waves and the cylindrical flowing fluid in a plurality of places.

It is also acceptable to soak an ultrasonic flaw detector for transmitting and receiving the ultrasonic waves and a glass panel in the non-compressive fluid.

This arrangement allows for avoiding a problem that may arise when cylindrical flowing fluids are produced as a non-compressive fluid at a plurality of places as described above, i.e., the problem that a plurality of flowing fluids interfere with each other to catch bubbles. This arrangement also allows for placing a number of ultrasonic flaw detectors for a glass panel having a large inspected area, thereby densely creating many paths for transmission and reception of ultrasonic waves. Even in this case, the glass panel and the ultrasonic flaw detector are soaked into the non-compressive fluid at high speeds or through agitation of the non-compressive fluid, thereby possibly causing bubbles to be caught. Thus, this may result in restrictions being imposed on the shortening of inspection time or the reduction of apparatus size.

In the aforementioned arrangement, the ultrasonic flaw detector for transmitting and receiving ultrasonic waves is preferably configured to move relative to a glass panel.

This arrangement in which the ultrasonic flaw detector moves relative to the glass panel would allow for detecting internal defects in all the areas of the face portion only with a minimal number of ultrasonic flaw detectors required to be arranged. In this case, the ultrasonic flaw detector is preferably provided with a plurality of transmission faces in a direction orthogonal to the direction of the relative movement. Furthermore, groups of a plurality of transmission faces are preferably arranged in a staggered configuration at a plurality of places in the direction of the relative movement. In this case, in connection with the face portion of the panel, it is necessary to arrange each of the transmission faces regularly so that no absence of transmission faces (or no area through which no transmission face passes during the relative movement) occurs in the direction of the relative movement.

The glass panel configured as described above is preferably a glass panel used for a projection cathode-ray tube.

This arrangement makes it possible to grasp the size and the position of an internal defect even in the direction of thickness of the face portion of the glass panel. Particularly, in the projection cathode-ray tube of this type for which the presence of an internal defect in the vicinity of the inner surface is considered to be critical, the presence of an internal defect in the vicinity of the inner surface can be thus accurately recognized to make a pass/fail decision and a decision on the validity of disposal. It is thus made possible to appropriately address the recent requirement for higher resolution of the cathode-ray tube of this type.

On the other hand, to achieve the aforementioned object, an apparatus according to the present invention is one for inspecting a glass panel for a cathode-ray tube, which includes a substantially rectangular fare portion and a skirt portion attached consecutively in a substantially perpendicular manner to a peripheral edge of the face portion. The apparatus is characterized by including an ultrasonic flaw detector for detecting the size and the depth of an internal defect in the face portion using ultrasonic waves.

As already described, an inspection apparatus configured as such employs the effect of the ultrasonic waves transmitted and received by the ultrasonic flaw detector to detect the size and the depth of an internal defect not only within a plane substantially parallel to the inner and outer surfaces of the face portion but also in the direction of thickness. It is thus possible to enjoy the same advantages as those described in the foregoing.

This apparatus can be configured to allow a cylindrical non-compressive fluid to flow down onto the outer surface or the inner surface of the face portion from an ultrasonic flaw detector probe when ultrasonic waves are transmitted from or received at the ultrasonic flaw detector probe of the ultrasonic flaw detector. Here, the non-compressive fluid flows down preferably by a free fall under its own weight.

Even this arrangement also allows for enjoying the aforementioned advantages that are provided by ultrasonic waves propagating through a non-compressive fluid as a medium. In addition, the non-compressive fluid adapted to fall freely causes no variation in flow rate, e.g., unlike a fluid being forcedly pumped to flow down, thereby allowing for appropriately preventing the occurrence of noise which would be otherwise caused by a variation in flow rate.

This apparatus can also be configured to soak the ultrasonic flaw detector probe of the ultrasonic flaw detector and a glass panel to be inspected into the non-compressive fluid.

With this arrangement, the ultrasonic flaw detector probe and the glass panel being soaked in the non-compressive fluid will eliminate the possibility of a gas such as air staying in the path for transmission and reception of ultrasonic waves. This allows for avoiding a problem that arises when cylindrical flowing fluids are allowed to flow down as a non-compressive fluid as described above and at a plurality of places due to a large area of the glass panel to be inspected, i.e., the problem that a plurality of flowing fluids interfere with each other to catch bubbles. The ultrasonic flaw detector probe and the glass panel, which are usually exposed to an ambient atmosphere (air), may be accompanied with air in the course of their entry into the non-compressive fluid. They enter the non-compressive fluid at high speeds or through agitation of the non-compressive fluid, possibly causing bubbles to be caught. Accordingly, this naturally imposes restrictions on the shortening of inspection time or the reduction of apparatus size.

To achieve the aforementioned object, a cathode-ray tube glass panel according to the present invention includes a substantially rectangular face portion and a skirt portion attached consecutively in a substantially perpendicular manner to a peripheral edge of the face portion. The glass panel is characterized in that a defect of 0.15 mm or more in diameter or maximum length does not exist within an area of 5 mm from the inner surface of the face portion.

That is, for example, since a glass panel used for a projection cathode-ray tube has the focal point of a projection lens system on the inner surface (fluorescent film) of the face portion, any internal defect present within the area of 5 mm from the inner surface of the face portion would be magnified and displayed in an image, e.g., as a black foreign object. For this reason, any internal defect present within an area of 5 mm (preferably within 3 mm) from the inner surface of the face portion preferably below 0.15 mm (preferably 0.1 mm or less) n diameter or maximum length.

In contrast to this, suppose that an internal defect is present in the vicinity of the middle of the face portion in the direction of its thickness or in the vicinity of the outer surface. In this case, the internal defect tends to be blurred in a wider area beyond recognition due to the lens effect of the internal defect being spaced apart from the focal point of the lens system. However, since too large an internal defect would tend to be easily displayed in an image, an internal defect present in the middle of the face portion in the direction of its thickness or in the vicinity of the outer surface has preferably a size of 0.5 mm or less.

With this arrangement, even a glass panel having an internal defect present within an area beyond 5 mm from the inner surface of the face portion is acceptable as a product unless the internal defect is problematic in relation to the area within 5 mm from the inner surface. It is thus possible to make a glass panel or glass bulb, which meet the required conditions and quality, commercially available as a product without being unnecessarily discarded.

### BRIEF DESCRIPTION OF THE DRAWINGS

FIG. 1 is a perspective view showing a cathode-ray tube glass panel according to an embodiment of the present invention;

FIG. 2 is a schematic front view showing an apparatus for inspecting a cathode-ray tube glass panel according to an embodiment of the present invention;

FIG. 3(a) is a schematic plan view showing an apparatus for inspecting a cathode-ray tube glass panel according to an embodiment of the present invention;

FIG. 3(b) is a schematic front view showing an apparatus for inspecting a cathode-ray tube glass panel according to an embodiment of the present invention;

FIG. 4 is a view showing a signal waveform representing the result of measurements made by an inspection apparatus according to an embodiment of the present invention;

FIG. 5 is an enlarged longitudinal sectional front view showing a cathode-ray tube glass panel according to an embodiment of the present invention;

FIG. 6(a) is a schematic plan view showing an apparatus for inspecting a cathode-ray tube glass panel according to another embodiment of the present invention;

FIG. 6(b) is a schematic front view showing an apparatus for inspecting a cathode-ray tube glass panel according to another embodiment of the present invention;

FIG. 7(a) is an enlarged longitudinal sectional front view showing a cathode-ray tube glass panel to explain a conventional problem;

FIG. 7(b) is an enlarged longitudinal sectional front view showing a cathode-ray tube glass panel to explain a conventional problem; and

FIG. 7(c) is an enlarged longitudinal sectional front view showing a cathode-ray tube glass panel to explain a conventional problem.

### DESCRIPTION OF THE PREFERRED EMBODIMENTS

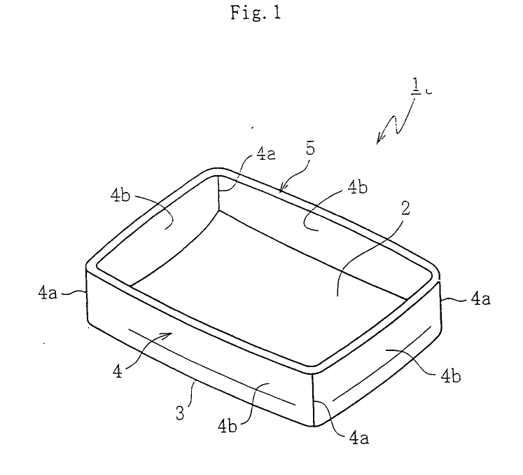

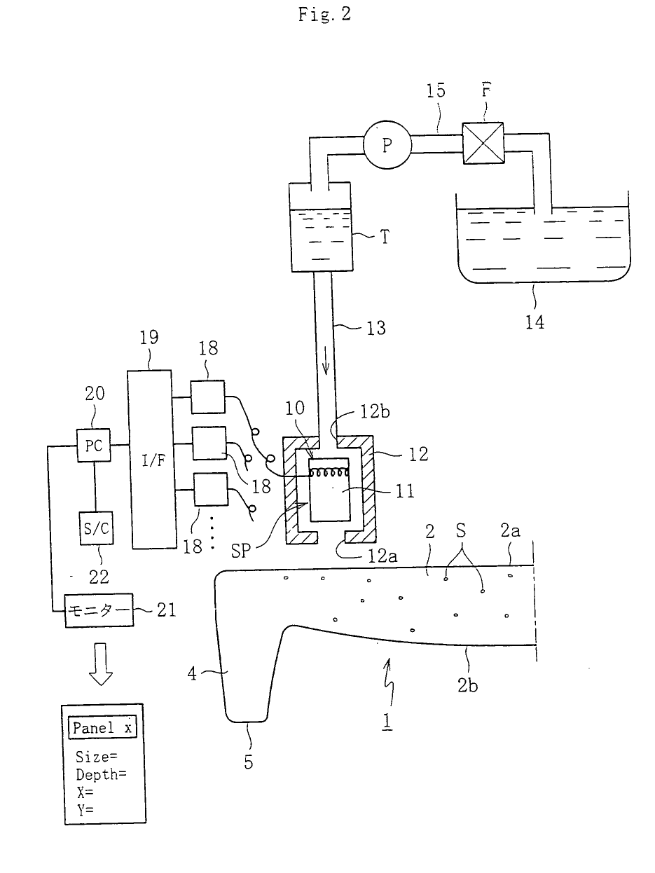

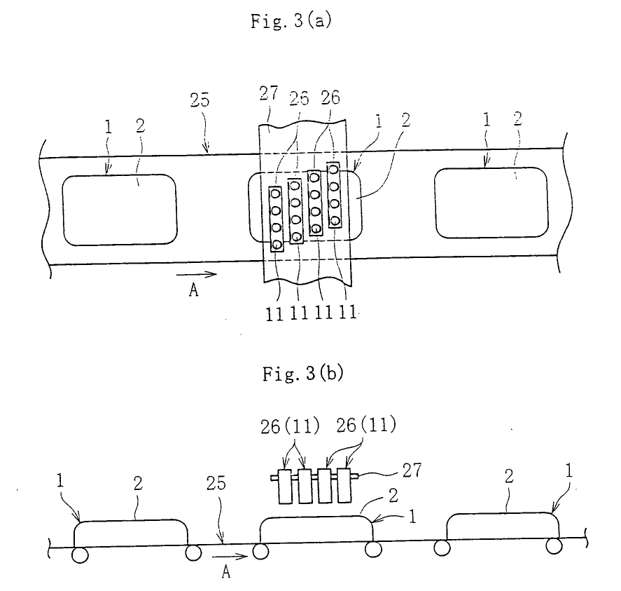

Now, embodiments of the present invention will be described below with reference to the accompanying drawings. FIG. 1 is a perspective view showing a projection cathode-ray tube glass panel (hereinafter simply referred to as a panel) according to an embodiment of the present invention. FIG. 2 is a schematic front view showing the main portion of an apparatus for inspecting the panel. FIG. 3(a) is a schematic plan view showing the entire inspection apparatus, FIG. 3(b) being a schematic front view showing the entire inspection apparatus.

As shown in FIG. 1, a panel 1 includes a face portion having an effective screen for displaying an image, and a skirt portion 4 consecutively provided in a substantially perpendicular manner on the peripheral edge of the face portion 2 via a blend R portion 3 so as to surround the face portion 2. The skirt portion 4 has side portions 4b consecutively coupled to each other at four diagonal portions 4a, in which a sealing edge face 5 serving for connection to a funnel is formed on the opening end at the top end of each of the side portions 4b.

FIG. 2 illustrates an inspection apparatus for detecting an internal defect S in the face portion 2 of the panel 1. As shown in the figure, the panel 1 is placed so that the outer surface 2a of the face portion 2 is oriented upwardly, while an ultrasonic flaw detector probe 11 of an ultrasonic flaw detector 10 is located 3 to 4 mm above off the outer surface 2a of the face portion 2. The ultrasonic flaw detector probe 11 is cylindrical in shape and provided at its bottom face with an ultrasonic-wave transmitter portion (serving also as a receiver portion) having a diameter of 3 mm.

The ultrasonic flaw detector probe 11 is covered with a channel forming member 12 which has an opening 12a provided at its bottom center for passing ultrasonic waves therethrough and an opening 12b provided at its top center for allowing a non-compressive fluid (hereinafter referred to as a fluid) to flow therein. The ultrasonic flaw detector probe 11 is adapted such that a fluid (pure water) having passed through the opening 12b on the top flows down through the opening 12a on the bottom via a fluid flowing space SP defined between the ultrasonic flaw detector probe 11 and the channel forming member 12.

The opening 12a on the top of the channel forming member 12 is in fluid communication with the bottom portion of a tank T provided thereabove via a fluid down-flow channel 13, such that pure water in the tank T falls freely through the fluid down-flow channel 13. Accordingly, the pure water falls freely from the opening 12a on the bottom of the channel forming member 12, thereby forming a pure-water column between the opening 12a and the outer surface 2a of the face portion 2. The tank T is configured to be fed with pure water in a water reservoir 14 through a supply channel 1 S, which is provided with a pump P for feeding the pure water under pressure to the tank T and upstream of which provided is a filter F for capturing foreign substances.

The ultrasonic flaw detector probe 11 is connected with an amplifier 18 for amplifying a signal for transmitting ultrasonic waves and/or a signal received. The amplifier 18 is connected with a microcomputer (personal computer) 20 via an interface circuit 19. The microcomputer 20 is connected with a monitor 21 for displaying he result of inspection on the panel 1 by means of the ultrasonic flaw detector 10, and a sequencer 22 for automatically discarding a panel when the panel is determined to be defective from its inspection result. As described later, the ultrasonic flaw detector 10 is provided with a plurality of ultrasonic flaw detector probes 11, each of which is connected with the amplifier 18.

In this case, as shown in FIGS. 3(a) and 3 (b), the panel 1 is placed on a transfer conveyor 25 so that the outer surface 2a of the face portion 2 is oriented upwardly. The panel 1 is transported in the direction shown by arrow “A”. On the other hand, the ultrasonic flaw detector 10 is configured such that a plurality of (four in the illustrated example) ultrasonic flaw detector probes 11 arranged in a direction orthogonal to the direction of the transportation are grouped into one detector unit 26, and the detector unit 26 is arranged at a plurality of places (four places in the illustrated example) in the direction of the transportation. The ultrasonic flaw detector 10 is held in place by means of a sustaining member 27. Each of the detector units 26 is arranged such that each of the ultrasonic flaw detector probes 11 is disposed in a staggered configuration. Additionally, each of the ultrasonic flaw detector probes 11 is arranged such that no absence thereof occurs in the direction of the transportation, i.e., the face portion 2 of the panel 1 to be transferred can be positively inspected over the entire area thereof by means of each ultrasonic flaw detector probe 11.

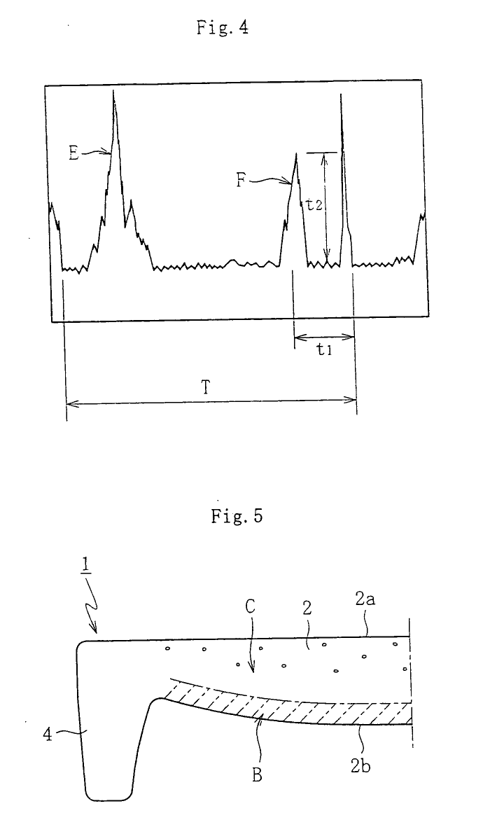

FIG. 4 shows a graph indicating an example of a signal waveform obtained by detecting the face portion 2 of the panel 1 along its thickness using ultrasonic waves. That is, an ultrasonic wave transmitted from the ultrasonic flaw detector probe 11 to propagate through a water column of pure water enters the face portion 2 through the outer surface 2a. At the entry portion, an ultrasonic wave propagates back and forth between the outer surface 2a and the ultrasonic flaw detector probe 11 disposed in close proximity thereto, thereby generating a large noise as indicated by symbol “E” in the figure. In contrast to this, a reflected wave from the inner surface 2b side of the face portion 2 has a sharp waveform with less noise. Thus, the reflected wave from an internal defect present in the vicinity of the inner surface 2b (within an area of 2 to 3 mm from the inner surface) appears clearly as indicated by symbol “F”.

In this case, the dimension t1 indicated in the figure represents the distance from the internal defect to the inner surface 2b of the face portion 2, while the dimension t2 represents the size (the diameter or the maximum length) of the internal defect. The dimension T shown in the figure represents the thickness of the face portion 2.

Here, ten panels 1 were prepared which included internal defects of 0.1 to 0.3 mm within an area of 0.6 to 5.5 mm from the inner surface 2b of the face portion 2. With the inspection apparatus configured as described above, those internal defects were inspected using an ultrasonic flaw detector probe 11 which emits an ultrasonic wave having a frequency of 10 MHz or preferably 20 MHz and a diameter (spot diameter) of the ultrasonic-wave transmitter of 10 mm or preferably 3 mm. The inspection was performed successfully to detect the internal defects in all the panels 1.

Defective panels were discarded in accordance with the inspection results obtained as described above, thereby providing a panel 1 as shown in FIG. 5. That is, for example, this panel 1 includes neither internal defects of 0.15 mm or more within an area B (the diagonally shaded area in the figure) of 5 mm from the inner surface 2b of the face portion 2 nor those of about 0.5 mm or more in the other area C.

In this case, according to the inspection apparatus shown in FIG. 2, the larger the area to be inspected, the larger the number of ultrasonic flaw detector probes 11 becomes. Thus, an increased number of ultrasonic flaw detector probes 11 would lead to the cylindrical flowing-down fluids being more narrowly spaced from each other to interfere with each other, thereby highly increasing the possibility of generating bubbles by catching the gas (air) present around the cylindrical fluids. This may result in generating noise in the waveform of the received signal. A problem like this can be effectively avoided by employing a configuration (e.g., one described below) in which the panel 1 to be inspected and the ultrasonic flaw detector probe 11 are soaked in the fluid.

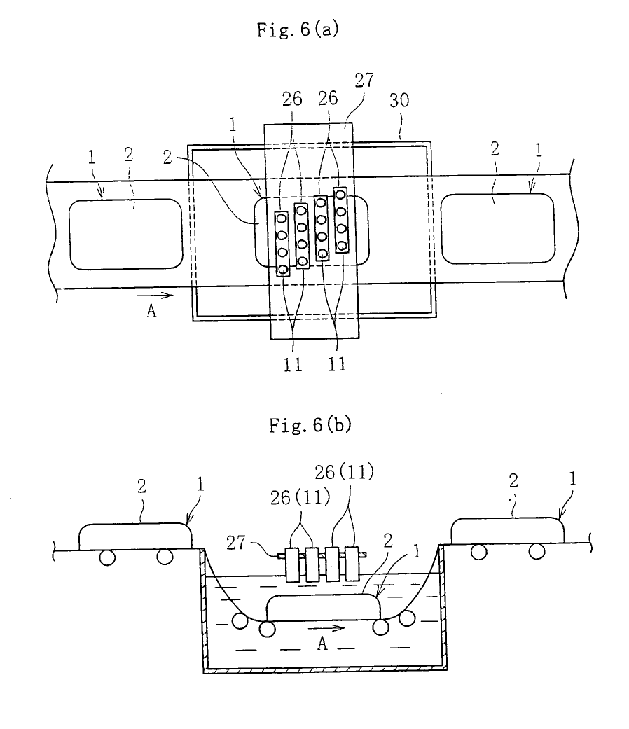

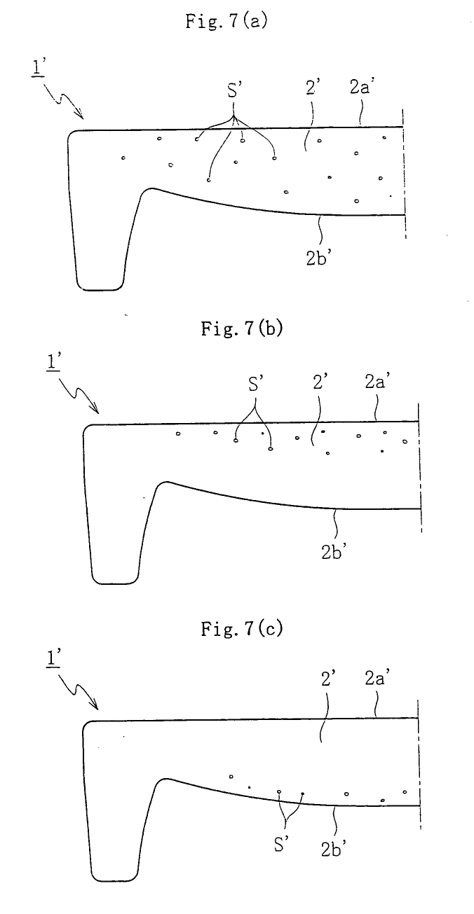

FIGS. 6(a) and (b) illustrate an inspection apparatus according to another embodiment of the present invention. Throughout the descriptions below in relation to FIGS. 6(a) and (b), the common components to those of the inspection apparatus according to the aforementioned embodiment are indicated by the same symbols and will not be explained repeatedly.

This inspection apparatus stores pure water as a non-compressive fluid in a water reservoir 30, and is configured to detect internal defects in the face portion 2 of the panel 1, with the transfer conveyor 25 to be driven in the direction of arrow “A”, the panel 1 to be placed thereon, and an ultrasonic-wave transmitter (serving also as a receiver) at the bottom portion of the ultrasonic flaw detector probe 11 being soaked in the pure water. According to this inspection apparatus, while the panel 1 transported on the transfer conveyor 25 Is soaked in the pure water, the panel 1 is inspected for internal defects in the face portion 2.

In such a configuration that the face portion 2 is inspected for internal defects with the transmitter of the ultrasonic flaw detector probe 11 and the face portion 2 of the panel 1 being soaked in the pure water, many ultrasonic flaw detector probes 11 can be arranged. Thus, this makes it possible to detect internal defects in a wide area of the face portion 2 as well as to appropriately detect internal defects in the face portion 2 even of a large panel 1.

According to this inspection apparatus, there is a possibility that bubbles may be produced around the panel 1 in the course of the panel 1 transported on the transfer conveyor 25 being soaked into the pure water, possibly causing noise to be generated in the waveform of a received signal. It is thus necessary to set the transportation (transfer) speed of the panel 1 to a speed slow enough not to generate bubbles.

Using this inspection apparatus, the panels No. 1 to No. 3 shown in Table 1 below were inspected for internal defects and checked if the internal defects were displayed in an image on the monitor. The results are shown in Table 1 below. In Table 1, the panels No. 1 and No. 2 represent an embodiment of the present invention, while the panel No. 3 represents a comparative example.

TABLE 1

| | Panel No. 1 | Panel No. 2 | Panel No. 3 |
|---|---|---|---|
| Size of defect present | ≦0.1 mm | No defect | ≧0.2 mm |
| on the inner surface | | | |
| side | | | |
| Size of defect present | No defect | ≦0.25 mm | No defect |
| on the outer surface | | | |
| side | | | |
| Presence of foreign | ◯ | ◯ | X |
| object | | | |

As can be seen clearly from Table 1 above, the panels No. 1 and No. 2 according to an embodiment of the present invention have defects of a size of 0.1 mm or less present within an area of 5 mm from the inner surface of the face portion and those of a size of 0.25 mm or less present in an area closer to the outer surface side than the aforementioned area. Thus, these defects were not displayed in an image on the monitor. In contrast to this, the panel No. 3 according to a comparative example has defects of a size of 0.2 mm or more present within an area of 5 mm from the inner surface of the face portion. Thus, those defects were displayed in an image on the monitor. As for the presence of foreign objects in Table 1 above, the panels were illuminated with light to project their enlarged images onto a screen via a projection lens system having a focal point on the inner surface (where a fluorescent film is formed) of their face portions. In this case, “◯” was noted when no black foreign object could be readily recognized, whereas “×” was noted when a black foreign object was recognized.

1. A method for inspecting a glass panel for a cathode-ray tube, the glass panel for a cathode-ray tube including a substantially rectangular face portion and a skirt portion attached consecutively in a substantially perpendicular manner to a peripheral edge of the face portion, the method comprising the step of detecting a size and a depth of an internal defect in the face portion using ultrasonic waves.

2. The method for inspecting a glass panel for a cathode-ray tube according to claim 1, wherein
ultrasonic waves are emitted from any one of the inner and outer surfaces of the face portion toward the other surface and a reflected wave reflected on the other surface and an internal defect is received, thereby detecting the size of the internal defect and the distance of the internal defect from the other surface.

3. The method for inspecting a glass panel for a cathode-ray tube according to claim 2, wherein
ultrasonic waves are emitted from the outer surface side of the face portion toward the inner surface side and a reflected wave reflected on the inner surface and an internal defect is received, thereby detecting the size of the internal defect and the distance of the internal defect from the inner surface.

4. The method for inspecting a glass panel for a cathode-ray tube according to claim 3, wherein
ultrasonic waves are allowed to propagate through a non-compressive fluid as a medium outside the face portion upon transmission and reception of the ultrasonic waves.

5. The method for inspecting a glass panel for a cathode-ray tube according to claim 4, wherein
the non-compressive fluid is a cylindrical flowing fluid that covers a path for transmission and reception of the ultrasonic waves and has a fluid channel area smaller than the inner and outer surfaces of the face portion.

6. The method for inspecting a glass panel for a cathode-ray tube according to claim 4, wherein
an ultrasonic flaw detector for transmitting and receiving the ultrasonic waves and the glass panel are soaked in the non-compressive fluid.

7. The method for inspecting a glass panel for a cathode-ray tube according to claim 5, wherein
the ultrasonic flaw detector for transmitting and receiving ultrasonic waves is configured to move relative to the glass panel.

8. The method for inspecting a glass panel for a cathode-ray tube according to claim 6, wherein
the ultrasonic flaw detector for transmitting and receiving ultrasonic waves is configured to move relative to the glass panel.

9. The method for inspecting a glass panel for a cathode-ray tube according to claim 4, wherein
the glass panel is a glass panel used for a projection cathode-ray tube.

10. An apparatus for inspecting a glass panel for a cathode-ray tube, the glass panel for a cathode-ray tube including a substantially rectangular face portion and a skirt portion attached consecutively in a substantially perpendicular manner to a peripheral edge of the face portion, the apparatus comprising an ultrasonic flaw detector for detecting a size and a depth of an internal defect in the face portion using ultrasonic waves.

11. The apparatus for inspecting a glass panel for a cathode-ray tube according to claim 10, wherein
the apparatus is configured to allow a cylindrical non-compressive fluid to flow down onto the outer surface or the inner surface of the face portion from an ultrasonic flaw detector probe when ultrasonic waves are transmitted from or received at the ultrasonic flaw detector probe of the ultrasonic flaw detector.

12. The apparatus for inspecting a glass panel for a cathode-ray tube according to claim 11, wherein
the ultrasonic flaw detector probe of the ultrasonic flaw detector and the glass panel to be inspected are soaked into the non-compressive fluid.

13. A cathode-ray tube glass panel being a cathode-ray tube component and comprising a substantially rectangular face portion and a skirt portion attached consecutively in a substantially perpendicular manner to a peripheral edge of the face portion, wherein a defect of 0.15 mm or more in diameter or maximum length does not exist within an area of 5 mm from the inner surface of the face portion.
